(19) United States
(12) Patent Application Publication
(10) Pub. No.: US 2003/0195858 A1
(43) Pub. Date: Oct. 16, 2003

(54) Distributed information storage, authentication and authorization system

(76) Inventors: Fujio Watanabe, San Jose, CA (US); Jingjun Cao, Mountain View, CA (US); Shoji Kurakake, San Francisco, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/120,165

(22) Filed: Apr. 10, 2002

(51) Int. Cl. G06F 17/60

(52) U.S. Cl. 705/75; 705/64; 705/78

(57) ABSTRACT

An on-line transaction approval system includes a service provider and a proxy server, along with a principal device operated by a principal. The principal has a user account with the on-line transaction approval system. A beneficiary operating a beneficiary device may be enabled to utilize the user account in on-line transactions. Upon receipt of an on-line service order request by the service provider from the beneficiary via the beneficiary device, the proxy server may receive a transaction request from the service provider. The principal device may receive notification of the service order request. The proxy server may provide authorized personal information to the service provider as a function of authentication of the beneficiary and authorization by the principal. The service provider may fulfill the service order request based on receipt of the authorized personal information.

### FIELD OF THE INVENTION

The present invention relates generally to one-line commercial transactions and more particularly, to methods and systems for authentication and authorization of such commercial transactions using distributed stored information.

### BACKGROUND

The ease and convenience of purchasing goods and services over electronic communication channels has improved dramatically in recent years. Not only are more goods and services providers making electronically based on-line commercial transactions available, but also security for consumers in such transactions has improved. This segment of the market, known commonly as “e-commerce,” will be increasingly utilized as more consumers gain access to electronic communication channels, and gain confidence in the security associated with on-line commercial transactions.

Even with improvements in security however, a consumer making such commercial transaction must still provide personal information, such as, for example, credit card numbers, social security numbers, name, date of birth, mailing address, etc. Thus, personal information of a consumer may be scattered in various locations, such as individual computers, product registry databases, cookies, web sites, etc, thereby increasing the risk of misuse of such information. Once personal information is provided at these various locations, consumers have little control over the information. Moreover, changes to previously provided personal information, such as, for example, a change of mailing address, must be updated at each different location where previous on-line commercial transactions have occurred. Further, each time a consumer desires to complete an on-line commercial transaction with a new provider of goods and/or services, the consumer must laboriously re-enter all the consumer personal information.

One prior art attempt to solve these issues is included in services provided by Microsoft®.Net. Microsoft®.NET includes identity services, authentication services and notification services enabled by Microsoft Passport services. In general, Microsoft® Passport services is a server-based architecture that maintains the personal consumer information of consumers who are users of the service in a “Passport.” The service utilizes standard secure socket layer (SSL) and hypertext transfer protocol (HTTP) methods to provide the personal consumer information to suppliers of goods and/or services at the direction of the users.

Among other features, the Microsoft® Passport service includes “Passport single sign-in (SSI) services” which allow users to create one name and password to access and perform on-line transactions with all web sites participating in the Passport service. Another feature is “Passport express purchase (EP) services” which provide users fast and secure online purchasing ability with the personal information prestored by the users in the “Passport.” An optional feature within the SSI services is “Kids Passport” which is a turnkey solution for obtaining parental consent to collect or disclose children's personal information. Kids Passport helps the users to comply with the requirements of the Children's Online Privacy Protection Act.

With Microsoft® Passport services, however, users must still provide personal consumer information to a third party, in this case, one or more Microsoft servers. In addition, authorization within Microsoft® Passport services does not include the ability for a user to detect and prevent personal information misuse. Once an authorized party, or principal, subscribes to Microsoft® Passport services and provides personal consumer information, any individual who gains access to the subscription of the authorized party may utilize the personal information (with or without permission). For example, an authorized party, such as a parent or employer, may willingly provide access to beneficiaries, such as, a child or an employee, respectively. Once such access is provided, the Microsoft® Passport services assumes any user with such access is the authorized party, which may not always be the case. Since the authorized party has no ability to approve, or otherwise monitor on-line transactions or other activities, misuse or malicious usage of consumer personal information may occur.

### SUMMARY OF THE PRESENT INVENTION

The presently preferred embodiments disclose an on-line transaction approval system. A principal may subscribe to the on-line transaction approval system and open a user account for use in on-line transactions. The principal may identify a beneficiary(s) that may also use the user account for on-line transactions. On-line transactions by the beneficiaries are subject to review and authorization by the principal. Accordingly, the on-line transaction approval system maintains a clear separation between the beneficiary(s) and the principal in on-line transactions. In addition, personal information associated with the user account of the principal remains in the control of principal and may be provided for on-line transactions following authorization.

The on-line transaction approval system includes at least one beneficiary device, at least one service provider, at least one proxy server and at least one principal device communicatively coupled. The beneficiary device and the principal device may be operated by a beneficiary and a principal, respectively. An on-line transaction may be initiated with the service provider by the beneficiary via the beneficiary device.

Initiation of the on-line transaction may involve sending a service order request for goods and/or services to the service provider. The service order request may include a beneficiary ID and a beneficiary password. The service provider may query the proxy server with a transaction request for authentication of the beneficiary and authorization by the principal of the service order request. The proxy server may return authorized personal information to the service provider to complete the on-line transaction as a function of authentication of the beneficiary and authorization by the principal.

In one embodiment, authorization by the principal involves authorization approval by the principal via the principal device. In this embodiment, the proxy server sends an authorization request to the principal device. The principal may review the authorization request and respond with authorization or denial of the transaction. The response of the principal is sent to the proxy server in an authorization response. If the principal authorizes the transaction, the authorized personal information of the principal may be included in the authorization response. The proxy server may forward a transaction response to the service provider that includes the principal's response and, where the transaction is authorized, the authorized personal information. The service provider may send a service order response to the beneficiary device, and supply goods/services where the principal authorized the transaction.

In another embodiment, authorization by the principal may involve the proxy server. In this embodiment, authorization may be performed by the principal similar to the previously described embodiment, or by the proxy server. Upon receipt of a transaction request from the service provider, the proxy server may make a pre-authorization decision. The pre-authorization decision determines whether the authorization approval is made in real-time directly by the principal, or indirectly by the proxy server without real-time authorization approval by the principal. The pre-authorization decision is made based on parameters specified by the principal at the proxy server. Where the proxy server decides to make the pre-authorization approval, the transaction response, including the authorized personal information is generated by the proxy server. Accordingly, in this embodiment, the authorized personal information is stored at the proxy server. In addition to generating the transaction response, the proxy server also sends an authorization request to the principal device indicating that pre-authorization approval of an on-line transaction by the proxy server has occurred.

An interesting feature of the on-line transaction approval system is authentication processing. As part of the on-line transaction approval process, the proxy server authenticates the beneficiary and the beneficiary device involved in the transaction, as well as the principal and the principal device.

Another interesting feature of the on-line transaction approval system is communication security. Communication within the system may be encrypted and decrypted using public and private keys, respectively. In addition, encrypted communications may be passed through the service provider and the proxy server without decryption to maintain security of the communications.

Yet another interesting feature of the on-line transaction approval system involves storage of personal information of the principal. In one embodiment, the personal information is stored only in the principal device. Accordingly, the principal maintains full control over dissemination and use regardless of the number of beneficiaries enabled to use the user account of the principal. In another embodiment, the personal information may also be stored at the proxy server. In this embodiment, the principal still maintains fill control over dissemination and use of the personal information since on-line transactions must be authorized by the principal.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 is a block diagram of an embodiment of an on-line transaction approval system 10.

FIG. 2 is a flow diagram of one embodiment of an on-line commercial transaction approval process of the on-line transaction system illustrated in FIG. 1.

FIG. 3 is a flow diagram of another embodiment of an on-line commercial transaction approval process of the on-line transaction approval system illustrated in FIG. 1.

FIG. 4 is a portion of the block diagram illustrated in FIG. 1 depicting a detailed block diagram of one embodiment of a proxy server.

FIG. 5 is a detailed block diagram illustrating one embodiment of a portion of the proxy server depicted in FIG. 4.

FIG. 6 is a detailed block diagram illustrating another embodiment of a portion of the proxy server depicted in FIG. 4, along with a reference company.

FIG. 7 is a portion of the block diagram illustrated in FIG. 1 depicting a detailed block diagram of one embodiment of a principal device.

FIG. 8 is a portion of the block diagram illustrated in FIG. 1 depicting a detailed block diagram of one embodiment of a service provider.

FIG. 9 is a portion of the block diagram illustrated in FIG. 1 depicting a detailed block diagram of a portion of one embodiment of a beneficiary device.

FIG. 10 is a flow diagram depicting one embodiment of the registration of a principal with the on-line transaction approval system illustrated in FIG. 1.

FIG. 11 is second portion of the flow diagram illustrated in FIG. 10.

FIG. 12 is a flow diagram depicting another embodiment of the registration of a principal with the on-line transaction approval system illustrated in FIG. 1.

FIG. 13 is second portion of the flow diagram illustrated in FIG. 12.

FIG. 14 is a flow diagram depicting one embodiment of the updating process of information stored within the on-line transaction approval system illustrated in FIG. 1.

FIG. 15 is a flow diagram depicting one embodiment of the approval process for an on-line transaction initiated by a beneficiary within the on-line transaction approval system illustrated in FIG. 1.

FIG. 16 is second portion of the flow diagram illustrated in FIG. 15.

FIG. 17 is third portion of the flow diagram illustrated in FIG. 15.

FIG. 18 is fourth portion of the flow diagram illustrated in FIG. 15.

FIG. 19 is fifth portion of the flow diagram illustrated in FIG. 15.

FIG. 20 is sixth portion of the flow diagram illustrated in FIG. 15.

FIG. 21 is seventh portion of the flow diagram illustrated in FIG. 15.

### DETAILED DESCRIPTION OF THE PREFERRED EMBODIMENTS

The presently preferred embodiments describe a method and system of authentication and authorization of on-line commercial transactions performed electronically. The method and system allows authorized personal information used in on-line commercial transactions to be maintained and controlled by subscribing users. In addition, the subscribing users may monitor and provide authorization of on-line transactions performed by beneficiaries enabled to utilize the personal information of the subscribing users. Accordingly, a clear separation between the beneficiary(s) and corresponding subscribing users is maintained during such commercial transactions.

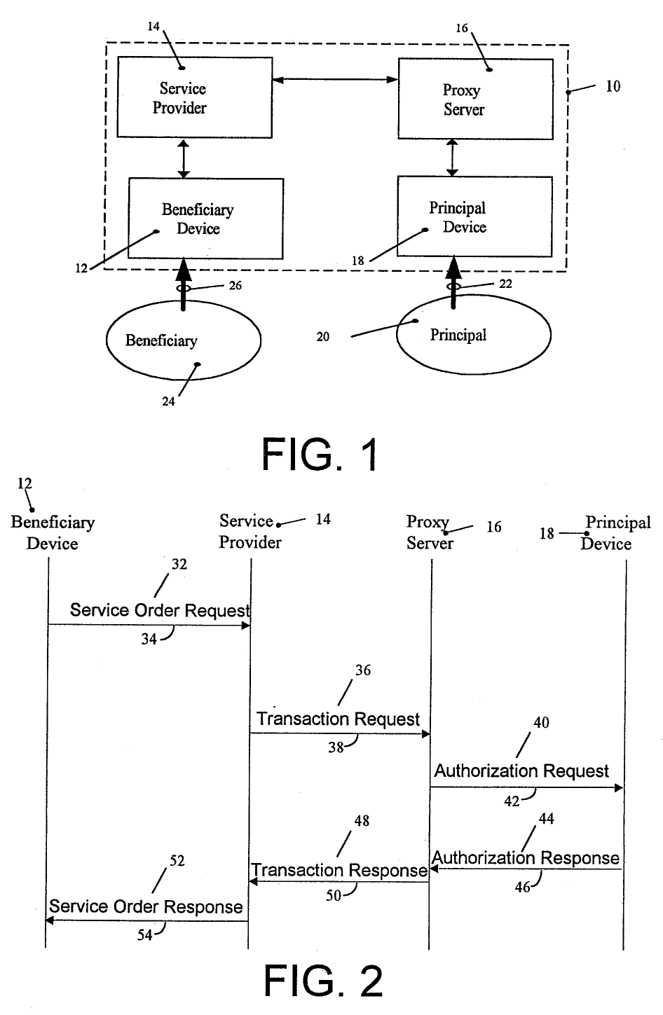

FIG. 1 is a block diagram of one embodiment of an on-line transaction approval system 10. The on-line transaction approval system 10 includes at least one beneficiary device 12, at least one service provider 14, at least one proxy server 16 and at least one principal device 18 coupled as illustrated. The term “on-line” refers to electronic communication of data, audio and/or video over electronic communication channels, such as, for example, wireline and/or wireless networks, as well as the Internet. Further, as used herein, the term “coupled”, “connected”, or “interconnected” may mean electrically coupled, optically coupled, wireless coupled or any other form of coupling providing an interface between systems, devices and/or components.

FIG. 1 also depicts at least one principal 20 operating the principal device 18 as illustrated by arrow 22. The principal 20 may be at least one subscribing user (or authorized party) of the on-line transaction approval system 10. As used herein, the term “principal” refers to an individual, company and/or organization that subscribe to the on-line transaction approval system 10. Subscription to the on-line transaction approval system 10 involves setting up a user account that includes personal information that includes sensitive and/or confidential information of the principal 20 for use in on-line commercial transactions. The principal 20 may be one or more individuals with the authority to monitor and authorize transactions involving the user account. In addition, the principal 20 may utilize the user account to perform on-line transactions.

“Personal information” may include credit card information, bank account information, name, street address, contact information, emergency information, personal policies and/or any other sensitive/confidential information related to the principal. As used herein, “electronic commercial transactions” or “on-line transactions” refers to purchases and/or requested purchases of goods and/or services performed over electronic communication channels. For example, utilizing a browser to contact a webserver over the Internet and selecting a book for purchasing may be considered an on-line, or electronic commercial transaction. In this example, personal information in the form of credit card information of the principal 20 may be provided to compensate the book supplier for the selected book.

FIG. 1 also illustrates at least one beneficiary 24 operating the beneficiary device 12 as indicated by arrow 26. The beneficiary 24 may be any user(s) enabled by the principal 20 to access the on-line transaction approval system 10. In the presently preferred embodiments, the beneficiary 24 performs on-line transactions utilizing the personal information from the user account of the principal 20 who provides enablement. Exemplary principals 20 and associated beneficiaries 24 include a parent and child(ren), an employer and employee or any other association that a principal 20 chooses to form with a corresponding beneficiary 24.

Enablement of the beneficiary 24 by the principal 20 involves identifying the beneficiary 24 within the user account of the principal 20 and assigning security clearance to the beneficiary 24. In the presently preferred embodiments, identification of the beneficiary 24 is with a beneficiary ID, and security clearance is in the form of a beneficiary password. The principal 20 may be similarly enabled to perform on-line transactions with the user account. In other embodiments, any other form of identification and security techniques may be utilized, such as, for example, a biological recognition system, etc.

The beneficiary device 12 may be any form of personal communication device capable of transmitting and receiving information over electronic communication channels, as well as manipulating such information. Exemplary beneficiary devices 12 include a wireless phone, a personal digital assistant (PDA), a handheld computer, a laptop computer, a desktop computer, a network terminal or any other device operable by the beneficiary 24 to perform on-line transactions. As illustrated in FIG. 1 by arrow 26, the beneficiary device 12 is in the control and operation of the beneficiary 24.

Security related functionality is also preferably included in the beneficiary device 12 to securely transmit sensitive data and other information. One exemplary standard for secure data transmission over the Internet is the well-known secure socket layer (SSL) connection. Another well-known form of secure data transmission involves applications with encryption/decryption capability utilizing a unique private key and a unique public key, such as, for example, pretty good privacy (PGP). The public key is used for encryption, while the private key is used for decryption of the encrypted communications. Accordingly, prior to sending an encrypted message, the public key of the intended recipient of the message is obtained for use in the encryption process. The beneficiary device 12 preferably uses private and public keys for secure communications with the service provider 14 and/or the proxy server 16.

The beneficiary 24 may initiate on-line transactions with the beneficiary device 12 over electronic communication channels. Upon initiation of an on-line transaction, a service order request may be generated. The service order request may include a service order and identification of the beneficiary 24. The service order may identify the goods and/or services that are the subject of the on-line transaction, such as, for example, book (qty. 1), by: AUTHOR, entitled: TITLE, cost: $$. Identification of the beneficiary 24 may be the beneficiary ID and the beneficiary password preferably encrypted with the public key of the service provider 14. In other embodiments, any other transactional related information may be included in the service order request. The service order request may be transmitted as a query to the service provider 14.

The service provider 14 may be any provider of goods and/or services capable of transacting on-line business over electronic communication channels. In the presently preferred embodiments, the service provider 14 is enabled to support the online transaction approval system 10 by a relationship such as, for example, a contractual agreement. Exemplary service providers 14 may perform on-line commercial transactions with a web server accessible over the Internet. In other embodiments, any other form of on-line service and/or merchandising may be representative of the service provider 14. The service provider 14 may also include security related functionality similar to the beneficiary device 12, and preferably utilizes public and private keys for secure communications.

Upon receipt of a service order request, the service provider 14 may generate a corresponding transaction request. The transaction request may include identification of the beneficiary 24, transaction information, an approval request and the public key of the service provider 14. The transaction information may include identification of the service provider 14, such as, with a unique service provider ID, and service information. The service information may include the service order as well as other information related to the nature of the transaction, such as, for example, a content age rating, a detailed description of the goods and/or services or any other information helpful in discerning the nature of the transaction. The approval request may include a request for authentication of the beneficiary 24 and a request for authorization of the transaction by the principal 20. In other embodiments, any other transactional related information may be included in the transaction requests. The transaction requests may be transmitted as a query to the proxy server 16.

The proxy server 16 may be any type of device capable of monitoring electronic communication channels for requests, processing such requests, and supplying information over electronic communication channels in response to requests within the on-line transaction approval system 10. Similar to the beneficiary device 12 and the service provider 14, the proxy server 16 may also include security related functionality, and preferably utilizes private and public key pairs for secure communications with the service provider 14 and the principal device 18.

As part of request and response processing, the proxy server 16 may perform real-time authentication and authorization processing.

Verification of the identity of the principal 20 and the beneficiary 24 by the proxy server 16 may be included as part of the real-time authentication processing. In addition, authentication processing may involve verifying the beneficiary device 12 and the principal device 18 operated by the beneficiary 24 and the principal 20, respectively. Further, authentication may involve verification of the personal information provided as part of an on-line transaction.

Real-time authorization processing may be based on the configuration and settings of the proxy server 16 and involves authorizing the beneficiary 24 to complete an on-line transaction. As part of an authorization approval, personal information may be provided as compensation to the service provider 14.

In one presently preferred embodiment, the proxy server 16 does not include personal information of the principal 20 in order to maintain confidentiality and limit the dissemination of such highly confidential information. Accordingly, personal information may be provided based on the real-time authorization approval of the principal 20. Authorization processing by the proxy server 16 of this embodiment may include generation of an authorization request for each transaction request. The authorization request may include the transaction information and identification of the beneficiary 24. Preferably, the authorization request includes a service provider ID, service information and a beneficiary ID. In other embodiments, any other transactional related information may be included in the authorization request. The authorization request may be transmitted as a query to the principal device 18 for real-time authorization approval by the principal 20.

The principal device 18 may be any form of personal communication device(s) capable of transmitting and receiving information over electronic communication channels, as well as manipulating such information. In the presently preferred embodiments, the principal device 18 is a wireless communication device. As illustrated by arrow 22 in FIG. 1, the principal device 18 is in the control and operation of the principal 20. Accordingly, communication with the principal 20 may be via the principal device 18. In addition, as part of the subscription process, the principal 20 may identify the principal device(s) 18 as well as preferences for communication of authorization requests from the proxy server 16. Preferences for communication may include, for example, time of day/device designations, preference rankings, content based designations, transaction originator designations, beneficiary designations, alternative principal devices 18 or any other parameters associated with contacting the principal 20.

The personal information of the principal 20 is preferably stored in the principal device(s) 18. As such, the personal information remains in the control of the principal 20, and may be directly updated and handled by the principal 20. In another embodiment, where the personal information is also stored in the proxy server 16 as described hereinafter, updates to the personal information stored in the principal device 18 may be mirrored to the personal information in the proxy server 16.

Following real-time review of an authorization request, the principal 20 may initiate the generation of an authorization response via the principal device 18 in real-time. Where the authorization request is approved, the authorization response may include authorization for the transaction and authorized personal information. “Authorized personal information” includes portions of the personal information of the principal 20 needed to complete the commercial transaction requested by the beneficiary 24 along with other related sensitive information of the principal 20. An authorization denied message absent the personal information may be included in the authorization response when the principal 20 disapproves of the transaction. The authorization response may be generated and directed to the proxy server 16.

In yet another presently preferred embodiment, the proxy server 16 is a private server computer utilized by one principal 20 privately operating the proxy server 16. Accordingly, personal information of the principal 20 may be saved in the principal device 18 and the proxy server 16 for maintenance and selective updating by the principal 20. In this embodiment, real-time authorization processing by the proxy server 16 may include a pre-authorization decision function. The pre-authorization decision function may be performed in real-time by the proxy server 16 without real time authorization approval by the principal 20.

The pre-authorization decision function by the proxy server 16 may include selectively transmitting an authorization request query to the principal device 18 based on preference decision rules. The preference decision rules may be one or more predetermined parameters set up by the principal 20 to allow pre-authorization decisions by the proxy server 16 in real-time of transaction requests meeting criteria set forth by the predetermined parameters. Based on application of the preference decision rules to the transaction request, the proxy server 16 may in real-time either provide pre-authorization approval of the transaction request, or may generate the authorization request query for transmittal to the principal device 18. Upon pre-authorization approval of a transaction request, the proxy server 16 may notify the principal 20 of the pre-authorization approval with a non real-time authorization request via the principal device 18.

In still other embodiments, the proxy server 16 may be a server computer utilized by a predetermined group of principals 20 subscribed to the on-line transaction approval system 10. In this embodiment, principal information may not be stored in the proxy server 16, and instead may be provided based on real-time authorization approval by the principal 20. In an alternative to this embodiment, principal information may preferably be separately stored in the proxy server 16 and securely accessed by the principal 20 who owns the personal information. The proxy server 16 of this embodiment may include the real-time pre-authorization decision and approval functionality as part of authorization processing.

Following authentication and authorization of the on-line transaction, the proxy server 16 may generate a transaction response. The transaction response may include an approval message and a proxy server transaction ID. Where the on-line transaction is approved, the transaction response may include an authorization message, an authentication message and authorized personal information of the principal 20. The service provider 14 may receive the transaction response and provide a service order response to the beneficiary device 12. The service order response may indicate that the service provider 14 will provide the requested goods and/or services, along with the authorized personal information when the transaction is approved. If the on-line transaction is disapproved due to authentication failure or authorization denial, the transaction response message may so indicate, and the service provider 14 may forward the denial information to the beneficiary device 12 in the service order response.

Once the principal 20 has subscribed to the on-line transaction approval system 10 and enabled the beneficiary 24, on-line commercial transactions with the service provider 14 may be performed. When the principal 20 is performing on-line transactions, following verification by the proxy server 16, authorized personal information may be provided to the service provider 14 to complete the transaction. When the beneficiary 24 is performing on-line transactions, however, authentication by the proxy server 16 as well as authorization of the transaction may occur prior to providing authorized personal information to the service provider 14.

Since a clear separation of the beneficiary 24 and the principal 20 exists in the transaction process, fraud and other misuse of the personal information of the principal 20 may be avoided. Further, the principal 20 may monitor and/or control on-line transactions of the beneficiary 24 with the ability to disallow objectionable transactions since the authorization process for on-line transactions of the beneficiary 24 is based on approval by the principal 20. In addition, since the principal 20 maintains full control of corresponding personal information, unauthorized use or access involving such information may be avoided.

FIG. 2 is a flow diagram illustrating one embodiment of an on-line commercial transaction approval process of the on-line transaction approval system 10 depicting encryption/decryption techniques for securely transmitting information. In this embodiment, the personal information of the principal 20 is stored only on the principal device 18 and the proxy server 16 does not perform pre-authorization approval of the on-line transaction. In addition, the public key of the proxy server 16 has been provided to beneficiary device 12.

Referring now to FIG. 2, the beneficiary 24 (FIG. 1) may generate a previously discussed service order request 32 with the beneficiary device 12. The service order request 32 may be forwarded to the service provider 14 as indicated by arrow 34. The beneficiary device 12 may encrypt the beneficiary identification included in the service order request 32 with the public key of the proxy server 16. In addition, the beneficiary device 12 may include the public key of the beneficiary device 12 in the service order request 32.

The service provider 14 may receive and process the service order request 32, and a previously described transaction request 36 may be generated based on the service order request 32. The beneficiary identification encrypted with public key of the proxy server 16 along with the public key of the service provider 14 may be encapsulated in the transaction request 36. The transaction request may be forwarded to the proxy server 16 as indicated by arrow 38 in FIG. 2. The proxy server 16 may receive and process the transaction request 36. Processing may include decrypting the beneficiary identification with the corresponding private key and generating a previously discussed authorization request 40. The authorization request 40 may be forwarded to the principal device 18 as illustrated by arrow 42.

Following display of the authorization request 40 on the principal device 18, the principal 20 may review the nature of the transaction and direct generation of a previously described authorization response 44. If the proxy server 16 is not secure, the principal device 18 may encrypt the authorized personal information with the public key of the service provider 14, and forward the authorization response 44 to the proxy server 16 as illustrated by arrow 46. If, on the other hand, the proxy server 16 is secure, the principal device 18 may encrypt the authorized personal information with the public key of the proxy server 16 and forward the authorization response 44.

The proxy server 16 may process the authorization response 44 and initiate generation of a previously described transaction response 48 encrypted by the public key of the service provider 14. If the authorization response 44 was encrypted with the public key of the proxy server 16, the proxy server 16 may decrypt the authorized personal information with the corresponding private key and re-encrypt the authorized personal information with the public key of the service provider 14 during generation of the transaction response 48. If, on the other hand, the authorization response 44 is encrypted with the public key of the service provider 14, the proxy server 16 may encapsulate the encrypted authorized personal information in the transaction response 48.

The transaction response 48 may be forwarded to the service provider 14 as illustrated by arrow 50. The service provider 14 may decrypt the transaction response 48 with the corresponding private key and generate a previously discussed service order response 52 based on the transaction response 48. The service order response 52 may be encrypted with the public key of the beneficiary device 12 and forwarded to the beneficiary device 12 as illustrated by arrow 54.

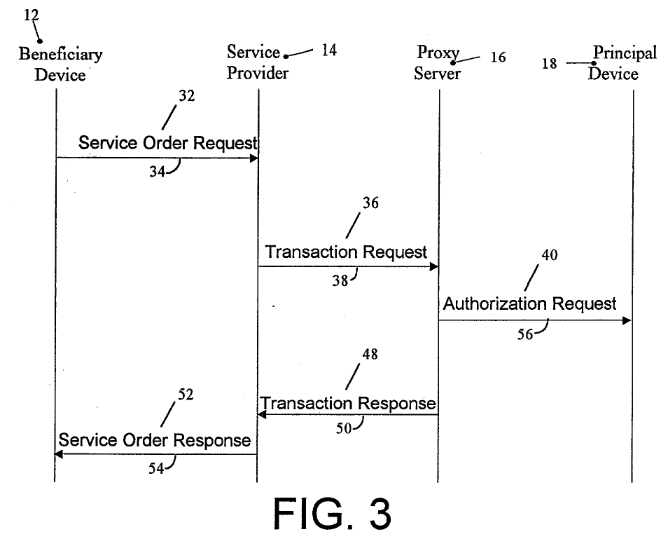

FIG. 3 illustrates another embodiment of a process flow diagram for securely transmitting information during commercial transaction approval processing with the on-line transaction approval system 10. In this embodiment, the personal information of the principal 20 may be stored on the principal device 18 and the proxy server 16. Accordingly, the proxy server 16 may include the previously discussed pre-notification authorization authority.

The encryption/decryption associated with transmittal of the service order request 32, the transaction request 36 and the service order response 52 are similar to the previous embodiments discussed with reference to FIG. 2. In this embodiment, however, a real-time authorization response from the principal device 18 is not needed when the proxy server 16 performs the pre-notification authorization. Accordingly, the proxy server 16 will encrypt locally stored authorized personal information, along with the remaining information included in the transaction response 48, with the public key of the service provider 14. In addition, the authorization request 40 may be forwarded by the proxy server 16 to the principal device 18 as illustrated by arrow 56. Since the authorization request 40 in this scenario is simply notification of the pre-authorization approval by the proxy server 16, real-time access to the authorization request by the principal 20 may be unnecessary. Similarly, a response by the principal 20 is unnecessary. In other embodiments, additional, fewer, or different encryption/decryption of the requests and responses may be utilized to maintain adequate security.

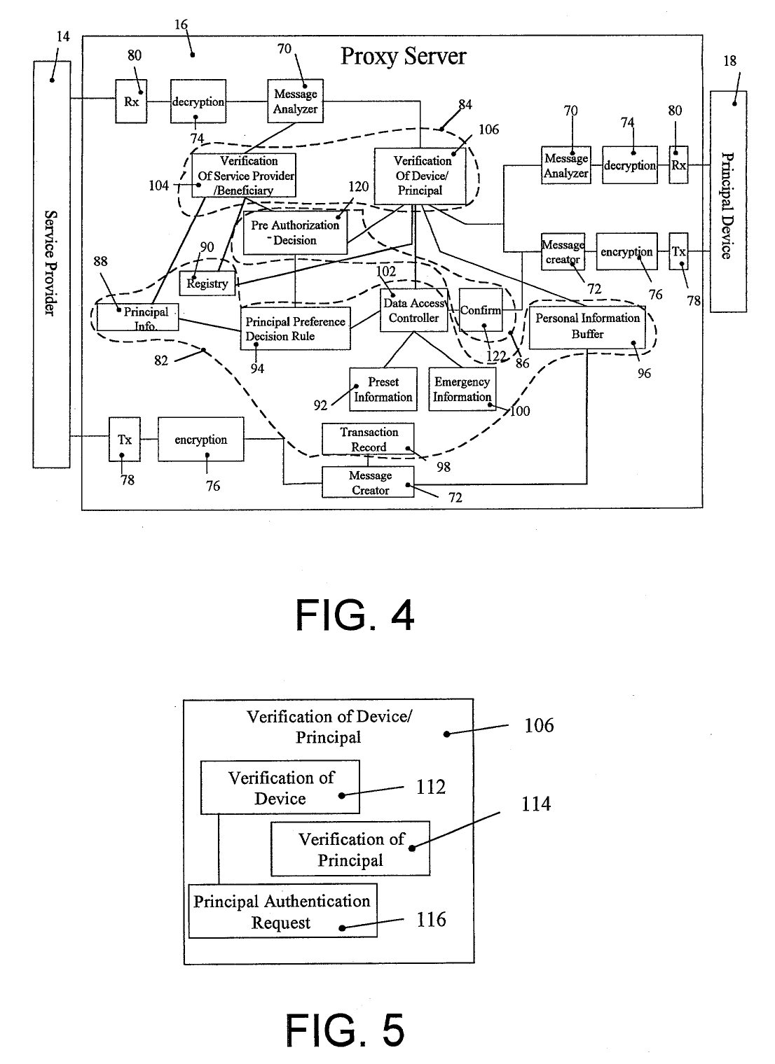

Referring now to FIG. 4, a more detailed block diagram of one embodiment of the proxy server 16 is coupled with the service provider 14 and the principal device 18 as illustrated. The proxy server 16 includes a plurality of message analyzer components 70 to recognize and understand the contents of received messages and a plurality of message creator components 72 to prepare messages for transmission. In addition, a plurality of decryption components 74 and a plurality of encryption components 76 to handle transmission security are included in the proxy server 16. The proxy server 16 also includes a plurality of transmit components (TX) 78 and a plurality of receive components (Rx) 72 to transmit and receive messages. Further, the proxy server 16 includes a proxy database module 82, an authentication processing module 84 and an authorization-processing module 86 coupled as illustrated. In other embodiments, fewer or greater numbers of modules and components may be depicted to describe the functionality of the proxy server 16.

The proxy database module 82 provides data storage and manipulation for data maintained and utilized in the proxy server 16. The proxy database module 82 of one embodiment includes a principal information component 88, a registry component 90, a preset information component 92, a principal preference decision rule component 94, a personal information buffer component 96, a transaction record component 98, an emergency information component 100 and a data access controller component 102 all coupled as illustrated. In other embodiments any other transactional related information may be included in the proxy database module 82. The principal information component 88 may store various information related to the principal 20 (FIG. 1), such as, for example, principal location, a principal current status, a server cache pointer and any other information related to the principal 20. The principal location may provide, for example, information on the current geographic and/or work-related location of the principal 20. The principal status may provide information related to the current activity of the principal 20, such as, for example, working, leisure time, sleeping, unreachable, in a conference meeting, etc. The server cache pointer may identify the location of information cached elsewhere. For example, the server cache pointer may include information useful in obtain personal information when the principal device 18 is stolen, lost, broken or loses all personal information.

The registry component 90 may store information related to principal device(s) 18, principal(s) 20 the beneficiary(s) 24 (FIG. 1) and corresponding beneficiary device(s) 12. Information related to the principal(s) 20 and beneficiary(ies) 24 may include, for example, identification and security clearance information, such as, for example, a user name and a unique identifier. Similarly information related to the beneficiary device(s) 12 and principal device(s) 18 may include an Internet protocol (IP) address, a wireless phone number or any other unique identifiers.

The preset information component 92 may include personal information of the principal 20 related to sensitive/confidential information for compensation of a provider of goods and/or services when the proxy server 16 is enabled for pre-authorization authority. As previously discussed, the personal information may be credit card information, bank account information, etc. Accordingly, the preset information component 92 is accessed as part of pre-notification approval to gather authorized personal information.

The principal preference decision rule component 94 may be pre-configured by the principal 20 to include parameters useful in making the pre-authorization decision as previously discussed. In addition, the principal preference decision rule component 94 may include contact information to communicate with the principal 20. In the presently preferred embodiments, the parameters include transaction threshold parameters, a current authenticated service providers list and a principal contact method preference.

The transaction threshold parameters may include parameters related to online transaction expenditure limits, acceptable categories of goods/services, payment method preferences, credit limits, fraud check information and/or any other threshold transactional parameters associated with each beneficiary 24 enabled by a corresponding principal 20. For example, the transaction list may identify a beneficiary 24 with a $100.00 spending limit for purchasing only books related to education.

The current authenticated service provider list may be generated by the principal 20 to selectively include service providers the principal 20 is comfortable doing business with. As such, if the beneficiary 24 makes a service order request from these authenticated service providers, approval of the commercial transaction may be expedited.

The principal contact method preference may provide primary communication preferences identified by the principal. In addition, the principal 20 may identify alternative communication preferences. The different preferences identified may be real-time communication channels, such as, for example, an audio or video channel and non-real time communication channels, such as, for example, a text channel. The alternative communication preferences may identify mechanisms for communication with the principal 20 when the primary communication preferences are unsuccessful or unavailable. For example, if a real-time authorization request sent to the principal device 18 on a primary communication preference is not responded to by the principal 20, the proxy server 16 may access the principal preference decision rule component 94. Using the principal preference decision rule component 94, the proxy server 16 may send an authorization request by another communication mechanism to contact the principal 20 such as, for example, non real-time (i.e., email).

The personal information buffer component 96 temporarily buffers the authorized personal information retrieved from the principal device 18 when an online transaction receives authorization approval from the principal 20 via the principal device 18. Accordingly, authorized personal information is extracted from the authorization response and buffered until the transaction response to the service provider 20 is generated by the message creator module 72. The transaction record component 98 may store on-line transaction related information such as, for example, information related to invoicing and payment of on-line commercial transactions. The emergency information component 100 may store various emergency information including medically related information pertaining to the principal 20, such as, for example, preferred physicians, known allergy(s), blood type etc. The data access controller component 102 manages access and updates to information contained within the various components of the proxy database module 82.

The authentication-processing module 84 of the illustrated embodiment includes a verification of service provider/beneficiary component 104 and a verification of device/principal component 106. The verification of service provider/beneficiary component 104 may perform authentication processing to verify whether the service provider 14 has a relationship with the on-line transaction approval system 10 (FIG. 1), and whether the beneficiary 24 is an authorized user based on information stored within the registry component 90.

FIG. 5 is a more detailed block diagram of one embodiment of the verification of device/principal module 106. The verification of device/principal module 106 includes a verification of principal device module 112, a verification of principal module 114 and a principal authentication request module 116. The verification of device/principal module 106 may be utilized to perform authentication of the principal device 18 (FIG. 4) and the principal 20 (FIG. 1) operating the principal device 18 using device information and principal 20 information provided in the principal information component 88 and the registry component 90.

Referring again to FIGS. 1 and 4, the authorization-processing module 86 of the illustrated embodiment includes a pre-authorization decision component 120 and a confirm component 122. The pre-authorization decision module 120 may logically determine whether the proxy server 16 will make the pre-authorization approval, or contact the principal 20 via the principal device 18, as previously discussed. Parameters on which the pre-authorization decision module 120 may logically base the pre-authorization approval decision are stored in the principal preference decision rule component 94. For example, pre-authorization approval decisions allowing the proxy server 16 to provide pre-authorization approval may be based on authenticated service providers. When a service provider 14 involved in a service order request has been authenticated, the proxy server 16 may provide pre-authorization approval and authorized personal information to the service provider 14 in order to start service quickly.

In addition, the pre-authorization decision module 120 initiates generation of a transaction response to the service provider 14 when the authority to make the pre-authorization approval message is approved. Further, the pre-authorization decision module 120 initiates generation of the authorization request to the principal device 18.

In the pre-authorization approved case, the pre-authorization decision module 120 gathers personal information to include as authorized personal information in the transaction response to the service provider 14. Once the authorized personal information is gathered, the pre-authorization decision module 120 may send the authorized personal information to the message creator component 72. In addition, the pre-authorization decision module 120 may activate the confirm component 122 to generate an authorization request to the principal device 18 indicating the proxy server 16 has provided pre-notification approval of an on-line transaction.

The confirm component 122 may generate a pre-authorization notice that is contained in an authorization request sent to the principal device 18. The pre-authorization notice may be designated as a non-real time message or a real-time message based on the preferences of the principal 20 established in the principal preference decision rule component 94. In addition, the confirm component 122 may generate an update notice sent to the principal 20 in an authorization request. The update notice may be provided in response to data updates made by the data access controller component 102 to the various components of the proxy database 82.

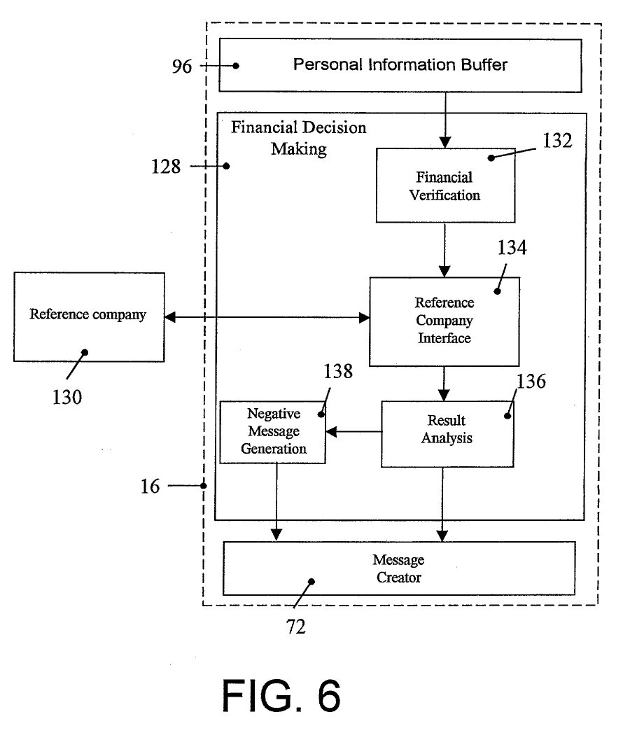

FIG. 6 is a block diagram of a portion of another embodiment of the proxy server 16. In this embodiment, the proxy server 16 includes a financial decision-making module 128 coupled with the personal information buffer component 96, the message creator component 72 and at least one reference company 130. The personal information buffer component 96 and the message creator component 72 are similar to the previous embodiments discussed with reference to FIG. 4.

The financial decision-making module 128 of this embodiment provides functionality within the proxy server 16 to confirm the validity of authorized personal information in view of a proposed on-line commercial transaction, especially in the case of monetary transactions. Accordingly, the financial decision-making module 128 may contact the reference company(s) 130 to verify the financial validity of authorized personal information such as, for example, credit card information. The reference company(s) 130 may be any business or organization capable of confirming availability of compensation and/or validity of personal information for an on-line commercial transaction, such as, for example, a credit card company or other financially related business.

The financial decision-making module 128 of the illustrated embodiment includes a financial verification component 132, a reference company interface component 134, a result analysis component 136 and a negative message generation component 138. The financial verification component 132 may determine whether the authorized personal information (i.e., the credit card information, etc.) should be verified before giving such personal information to the service provider 14 (FIG. 1). Determination may be based on the credit history of the principal 20 (FIG. 1), nature of the personal information or any other financially related criteria.

The reference company interface component 134 may provide communication with the reference company(s) 130 through a communication path, such as, for example, wireless communication and/or wireline communication, using text, video and/or audio communication medium(s). The result analysis component 136 may verify whether a commercial transaction is to proceed based on results provided by the reference company(s) 130 via the reference company interface component 134 in response to a request for such information. In addition, where the results are positive, a positive message may be sent by the result analysis component 136 to the message creator component 72. The negative message generation component 138 may generate indication that the subject transaction cannot proceed along with a reason as directed by the result analysis component 136. The indication and reason may be sent to the message creator component 72.

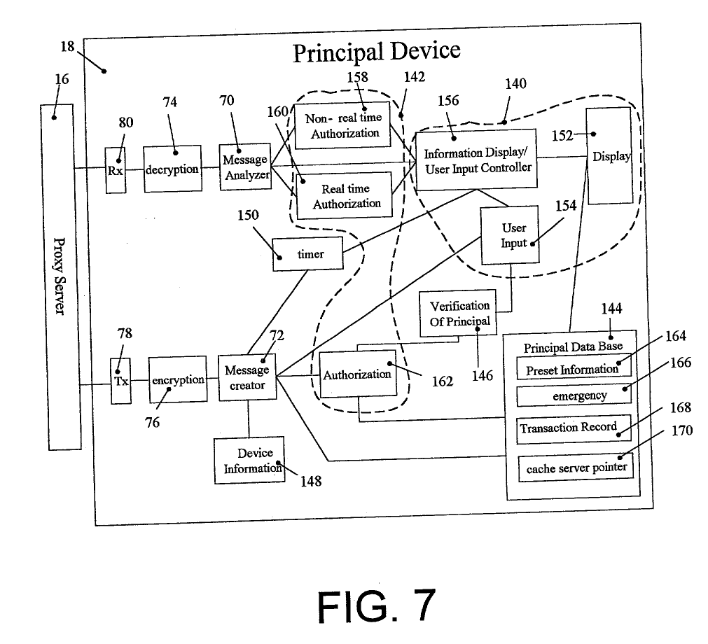

Referring now to FIG. 7, a more detailed block diagram of one embodiment of the principal device 18 depicted in FIG. 1 is coupled with the proxy server 16 as illustrated. Similar to the proxy server 16, the principal device 18 includes a message analyzer component 70, a message creator component 72, a decryption component 74, an encryption component 76, a transmit component (TX) 78 and a receive component (Rx) 72 coupled as illustrated. As previously discussed, the encryption component 76 may encrypt outgoing responses with either the public key of the service provider 14 (FIG. 1) or the proxy server 16 depending on the security level of the proxy server 16. In addition, the principal device 18 includes a user interface module 140, an authorization module 142, a principal database 144, a verification of principal component 146, a device information component 148 and a timer component 150. In other embodiments fewer or greater numbers of components and modules may be used to illustrate the functionality of the principal device 18.

The user interface module 140 includes a display component 152, a user input component 154 and an information display/user input controller component 156 coupled as illustrated. The display component 152 may be any mechanism capable of generating and displaying video and/or text information on a graphical user interface (GUI) of the principal device 18 for viewing by the principal 20 (FIG. 1). The user input component 154 may be any mechanism for sensing user inputs such as, for example, a touch screen, a pointing device, a keypad, a voice sensor, etc. User inputs may be received by the user input component 154, processed and provided to the information display/user input controller component 156. The information display/user input controller component 156 may process information and direct the operation of the display component 152, and/or the user input component 154.

The authorization module 142 includes a non-real time authorization component 158, a real-time authorization component 160 and an authorization component 162 coupled as illustrated. The non-real time authorization component 158 may process non-real time authorization requests sent from the proxy server 16 and forward the information from such requests to the information display/user input controller component 156 for display by the display component 152. The real-time authorization component 160 may similarly process real-time authorization requests sent from the proxy server 16. The authorization component 162 may determine what information should be included in an authorization response based on the nature of the on-line transaction, and extract such information from the principal database 144.

The principal database 144 of the illustrated embodiment includes preset information 164, emergency data 166, transaction record data 170, and cache server pointer data 168. The preset information 164 includes sensitive/confidential information related to compensating a provider of goods and/or services, similar to the previously discussed proxy server 16. Similar to the proxy server 16, the emergency data 166 is input by, and pertains, to the principal 20 (FIG. 1), the transaction record data 168 stores authorized transaction data and the cache server pointer data 154 may identify the location of data stored in another cache. As previously discussed personal information as well as other related data may also be stored in the proxy server 16 when the proxy server 16 includes pre-authorization authority.

The verification of principal component 146 may authenticate the principal user as an authorized user of the on-line transaction approval system 10 (FIG. 1). Authentication may be based on comparison of information stored in the principal database 144 with a unique identifier provided by the principal 20 (FIG. 1). The unique identifier may be any authorization mechanism capable of identifying the principal 20, such as, for example, a code, a biological scanner input, etc. In the presently preferred embodiments, the unique identifier is a personal identification number (PIN) code that may be input via the user input component 154.

The device information component 148 may include principal device 18 related information, such as, for example, a unique device identification number, IP address, etc.

The timer component 150 may perform a watchdog function to confirm the principal 20 (FIG. 1) provides a response to transaction requests from the service provider 14 in a timely manner. Upon time out of the timer component 150, due to lack of response by the principal 20, the timer component 150 may alert the proxy server 16 of the lack of response by the principal 20. The time out may be based on a predetermined time period, or a variable time period based on analysis of existing variable parameters, such as, for example, indication that the principal is engaged in other activities involving the principal device 18.

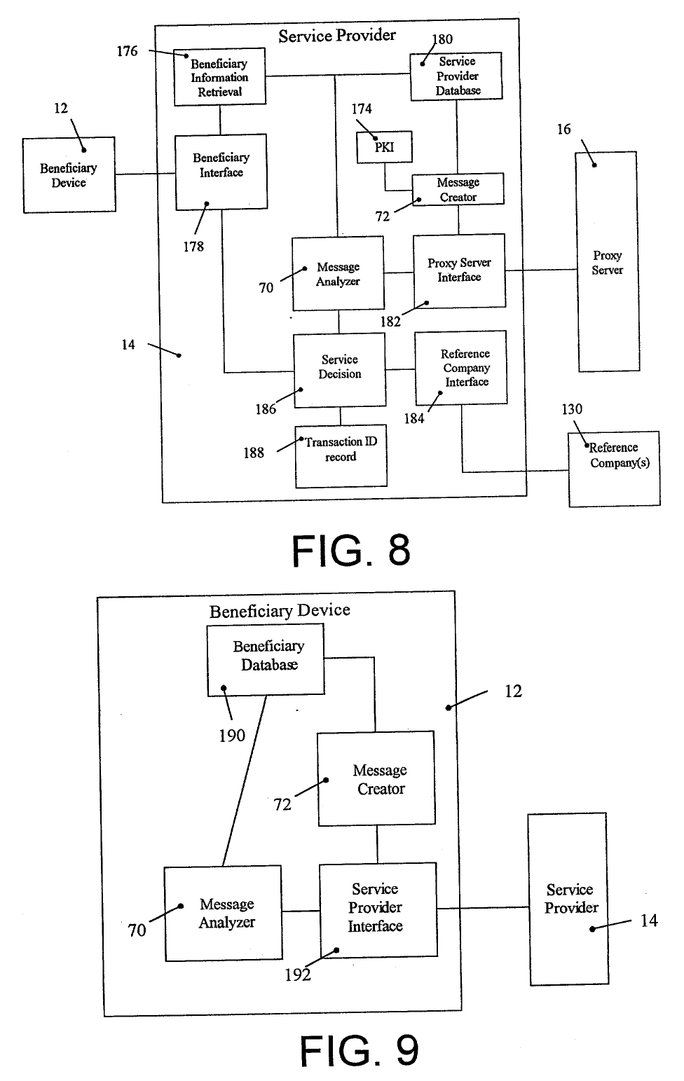

FIG. 8 is a more detailed block diagram of one embodiment of the service provider 14 depicted in FIG. 1. The service provider 14 is coupled with the beneficiary device 12, the proxy server 16 and at least one reference company 130 as illustrated.

As further illustrated in FIG. 8, the service provider 14 includes a message analyzer component 70 and a message creator component 72 similar to the proxy server 16 and the principal device 18 discussed with reference to FIGS. 4 and 7, respectively. The message creator component 72, however, may also generate the request for beneficiary authentication and the request for principal authorization included in the transaction request as previously discussed. The service provider 14 also includes a PKI component 174, a beneficiary information retrieval component 176, a beneficiary interface component 178, a service provider database 180, a proxy server interface component 182, a reference company interface component 184, a service decision component 186 and a transaction ID record component 188. In other embodiments, fewer or greater numbers of components may be included to illustrate the functionality of the service provider 14.

The PKI component 174 may handle the generation of the service provider 14 public key, as well as other message security related functionality, such as, for example, decryption using the private key of the service provider 14. The beneficiary information retrieval component 176 may extract the information provided in service order requests from the beneficiary device 12. In one embodiment, the beneficiary information retrieval component 176 may extract the beneficiary identification (e.g. beneficiary ID and password) and the service order from the service order requests. The beneficiary interface component 178 may provide a communication path for communication with the beneficiary device 12, such as, for example, wireless communication and/or wireline communication, using text, video and/or audio communication medium(s).

The service provider database 180 may store beneficiary related information and service order related information pertaining to the on-line commercial transaction. The proxy server interface component 182 may provide a path for communication with the proxy server 16 similar to the beneficiary interface component 178. Similarly, the reference company interface component 184 may provide a communication path with the reference company(s) 130. The service decision component 186 may make the decision regarding providing goods and/or services. Preferably, the decision is based on analysis of the transaction response from the proxy server 16 to identify a positive authentication approval, a positive authorization approval, the proxy server transaction ID and an affirmative response from the reference company(s) 130. The transaction ID record component 188 may include storage of the transaction ID sent with the transaction response from the proxy server 16, along with associated beneficiary identification and any other transaction related information.

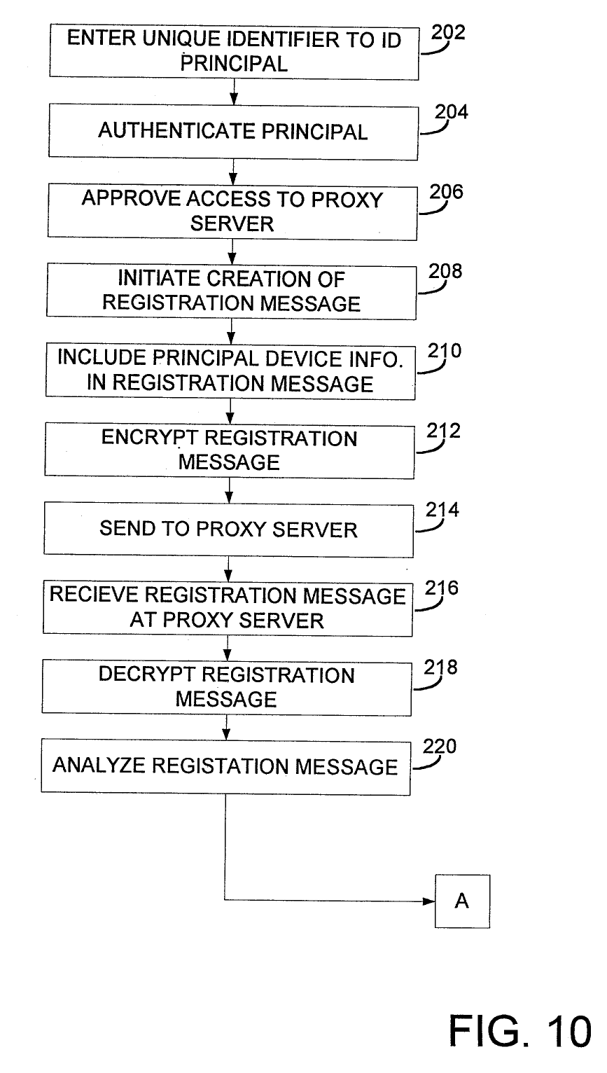

Referring now to FIG. 9, a more detailed block diagram of one embodiment of the beneficiary device 12 depicted in FIG. 1 is coupled with the service provider 14 as illustrated. The beneficiary device 12 includes a message analyzer 70 and a message creator 72 as in the previous embodiments. In addition, the beneficiary device 12 includes a beneficiary database 190 and a service provider interface component 192. The beneficiary database 190 may include the beneficiary identification and beneficiary password included with the service order requests for authentication of the beneficiary 24 (FIG. 1). The service provider interface component 184 may provide a path for communication with the service provider 14 similar to the interfaces of the previously discussed embodiments. In other embodiments, fewer or greater numbers of components may be depicted to describe the functionality of the beneficiary device 12.

With reference to FIGS. 1, 4, 5, 6, 7, 8 and 9, operation of the on-line transaction approval system 10 will now be discussed.

FIG. 10 is a flow diagram illustrating exemplary operation of the components within the principal device 18 and the proxy server 16 during registration of the principal 20 with the on-line transaction approval system 10. In this exemplary operation, the principal 20 has previously subscribed to the on-line transaction approval system 10 and configured the proxy server 16 and the principal device 18 with data, such as, for example, personal information, identification-related information, preferences, etc. In addition, the principal device 18 and the proxy server 16 have previously exchanged public keys.

When the principal device 18 is activated, the principal 20 may input a unique identifier (e.g. PIN code) via the user input component 154 to authenticate the authorized user at block 202. At block 204, the verification of principal component 146 authenticates the principal 20 as an authorized user. Access to the proxy server 16 may be approved by the authorization component 162 at block 206. At block 208, creation of a registration message may be initiated with the message creator component 72. The message creator component 72 may include principal device information stored in the device information component 148 in the registration message at block 210. At block 212, the registration message may be encrypted with the public key of proxy server 16 by the encryption component 76. The encrypted registration message may be sent to the proxy server 16 via the Tx component 78 at block 214.

At block 216, the encrypted registration message is received by the Rx component 80 of the proxy server 16. Decryption of the registration message is performed with the decryption component 74 at block 218. At block 220 the decrypted registration message is analyzed by the message analyzer 70.

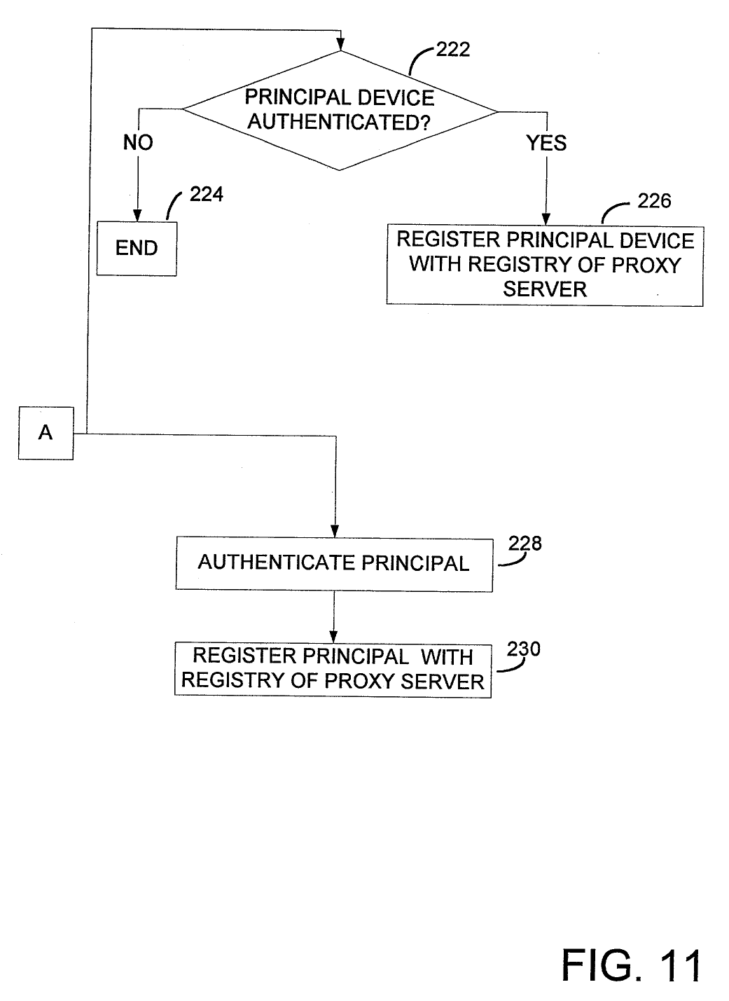

Referring now to FIG. 11, the principal device 18 is authenticated with the verification of device component 112 at block 222. If the principal device is not successfully authenticated, the registration ends at block 224. If the principal device 18 is successfully authenticated, the principal device 18 is registered with the registry component 90 at block 226. In addition, at block 228, the principal 20 is authenticated with the verification of principal component 114. Since the principal device 18 previously authenticated the user as the principal 20 using the PIN, at block 204 (FIG. 10), the proxy server 16 may automatically authenticate the principal 20. Accordingly, the principal 20 is registered with the registry component 90 at block 230.

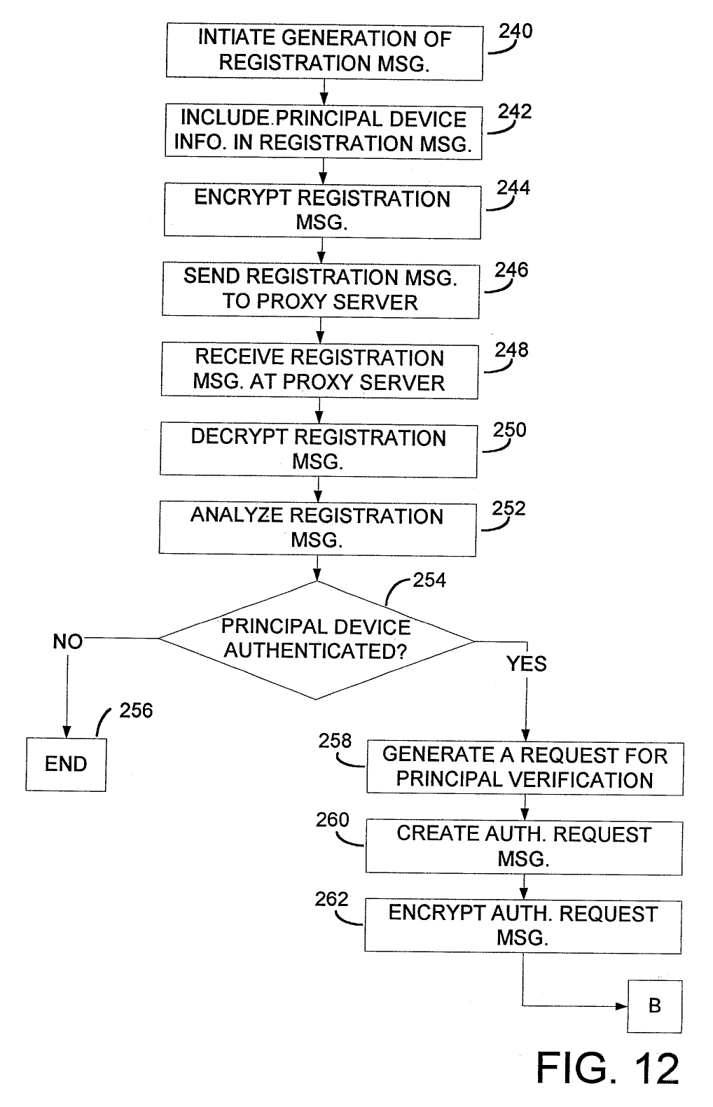

FIG. 12 is a flow diagram illustrating exemplary operation of the components within the principal device 18 and the proxy server 16 during registration of any one of a plurality of principals 20 with the on-line transaction approval system 10 using the same principal device 18. Similar to the embodiments previously discussed with reference to FIGS. 10 and 11, subscription and configuration has previously occurred for each of the principals 20. In this exemplary operation, authentication of the principal 20 is handled separately from the authentication of the principal device 18 at the proxy server 16.

When the principal device 18 is activated, creation of a registration message may be initiated with the message creator component 72 at block 240. At block 242, the message creator component 72 may include principal device information stored in the device information component 148 in the registration message. The registration message may be encrypted with the public key of proxy server 16 by the encryption component 76 at block 244. At block 246, the encrypted registration message may be sent to the proxy server 16 via the Tx component 78.

At block 248, the encrypted registration message is received by the Rx component 80 of the proxy server 16. At block 250, decryption of the registration message is performed with the decryption component 74. The decrypted registration message is analyzed by the message analyzer 70 at block 252. The principal device 18 is authenticated with the verification of device component 112 at block 254. If the principal device is not successfully authenticated, the registration ends at block 256. If authentication is successful, at block 258, a request for principal verification is generated at the principal authentication request component 116. The principal authentication request component 116 forwards the request to the message creator component 72 to create an authentication request message at block 260. The authentication request message is encrypted by the encryption component 76 at block 262.

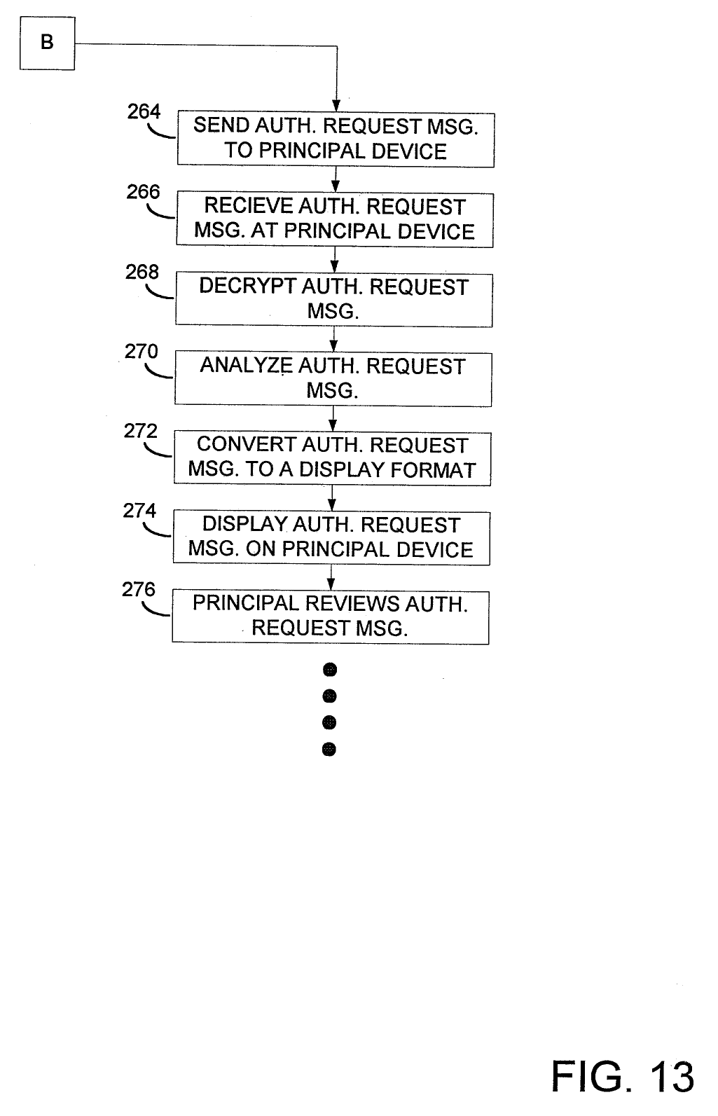

Referring now to FIG. 13, at block 264, the encrypted authentication request message is sent to the principal device 18 via the Tx component 78. The principal device 18 receives the encrypted authentication request message with the Rx component 80 at block 266. At block 268, the encrypted authentication request message is decrypted by the decryption component 74. The message analyzer component 70 analyzes the message and extracts the authentication request message at block 270. At block 272, the message is forwarded to the information display/user input controller component 156 for conversion to a display format. The information display/user input controller component 156 directs the display component 152 to display a message requesting verification information from the principal 20 at block 274. At block 276, the principal 20 reviews the request for authentication information. The principal 20 then enters a unique identifier and is authenticated as previously discussed with reference to FIGS. 10 and 11. Accordingly, for purposes of brevity, illustration and description of this portion of the registration process will not be repeated.

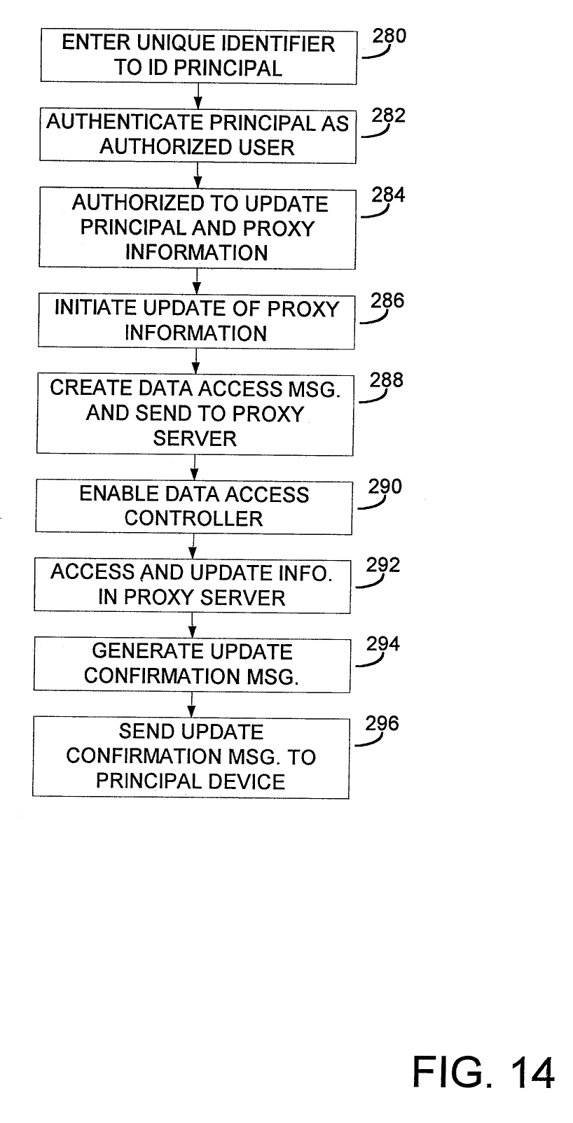

FIG. 14 is a flow diagram illustrating exemplary operation of the components within the principal device 18 and the proxy server 16 of the on-line transaction approval system 10 during information update processing. Similar to the previously discussed embodiments subscription and configuration has previously occurred.

When the principal device 18 is activated, the principal 20 may input a unique identifier (e.g. PIN code) via the user input component 154 to authenticate the authorized user at block 280. At block 282, the verification of principal component 146 authenticates the principal 20 as an authorized user. The principal 20 is authorized at block 284 to update preset information 164, emergency data 166 and cache server pointer data 170 within the principal database 144 as well as information stored in the proxy database module 82 at the proxy server 16. As previously discussed, changes made to data in the principal database 144 may be mirrored to data stored in the proxy database module 82 by a data access message(s). In addition, the principal 20 may update the data stored in the proxy database module 82 with a data access message(s).

At block 286, the principal 20 elects to initiate updating the data at the proxy server 16. The creation of a data access message may be initiated with the message creator component 72 and sent to the proxy server 16 at block 288. The encryption, transmittal, receipt, decryption and verification by the proxy server 16 of the data access message is similar to the operations described with reference to FIGS. 10 and 11, and therefore are not repetitively illustrated or described. At block 290, based on positive authentication by the verification of device component 112 and positive authentication by the verification of principal component 114, the data access controller component 102 is enabled. The data access controller component 102 may handle accessing and updating of stored information in the proxy database module 82 as directed by the principal 20 at block 292. After the information is updated, the confirm component 122 may initiate generation of an update confirmation message at block 294. The update confirmation message may be sent to the principal device 18 at block 296. The generation, encryption, transmission, receipt, decryption, analysis and display at the principal device 18 of the update confirmation message are similar to the operations described with reference to FIGS. 12 and 13, and therefore are not repetitively illustrated or described.

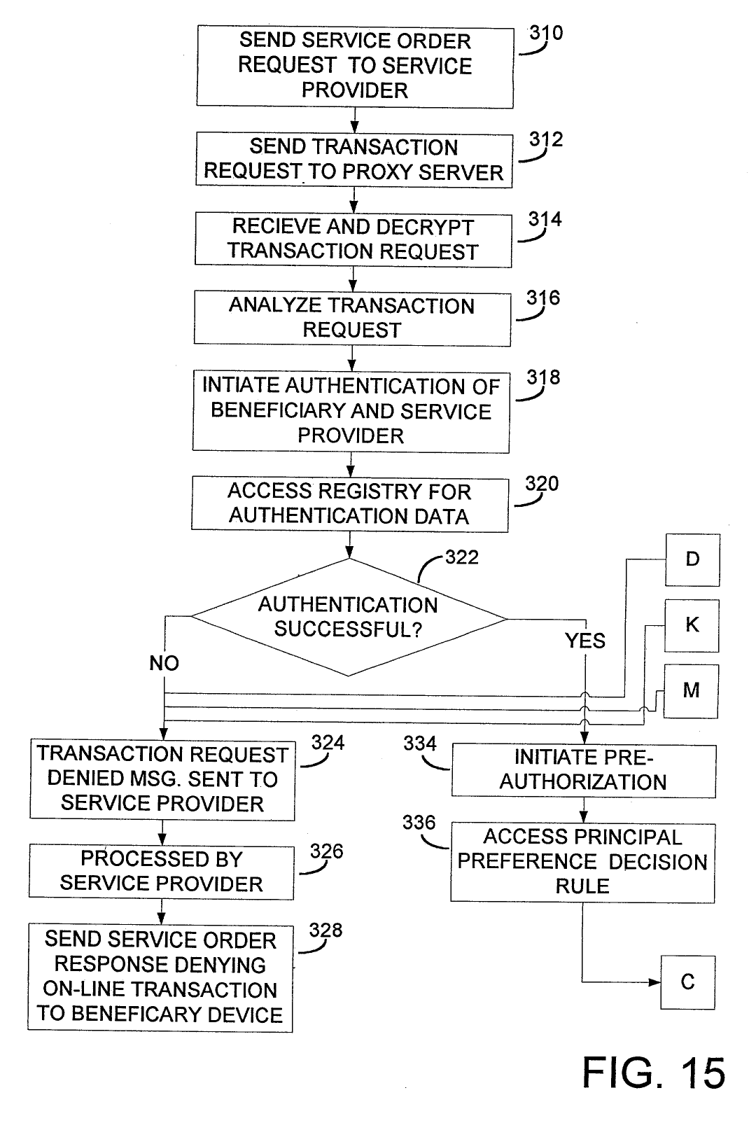

FIG. 15 is a flow diagram illustrating exemplary operation of the components within the principal device 18 and the proxy server 16 of the on-line transaction approval system 10 when the beneficiary device 12 generates a service order request. Similar to the previously discussed embodiments subscription and configuration has previously occurred.

A service order request that includes beneficiary identification and a service order is generated by the beneficiary device 12 and sent to the service provider 14 at block 310. At block 312 in response to the service order request, the service provider 14 may send a transaction request to the proxy server 16 in order to authenticate the beneficiary 24 and get authorization for the requested transaction. The transaction request may be received by the proxy server 16 with the Rx component 80 and decrypted with the decryption component 74 at block 314.

The message analyzer component 70 may analyze the transaction request at block 316. At block 318, authentication of the beneficiary 24 and the service provider 14 may be initiated by the verification of service provider/beneficiary component 104. The verification of service provider/beneficiary component 104 may access the data in registry component 90 to perform the authentication at block 320. At block 322, a determination of whether the authentication was successful occurs.

If the authentication was unsuccessful, a transaction request denied message is encapsulated in a transaction response along with the proxy ID of the proxy server 16 at block 324. At block 326, the service provider 14 receives and decrypts the transaction response, and processes the transaction request denied message. The service order response indicating the on-line transaction is denied is sent to the beneficiary device 12 at block 328. If the authentication was successful, pre-authorization will be initiated with the pre-authorization decision component 120 at block 334. The pre-authorization decision component 120 may access the principal preference decision rule component 94 at block 336 in making this decision.

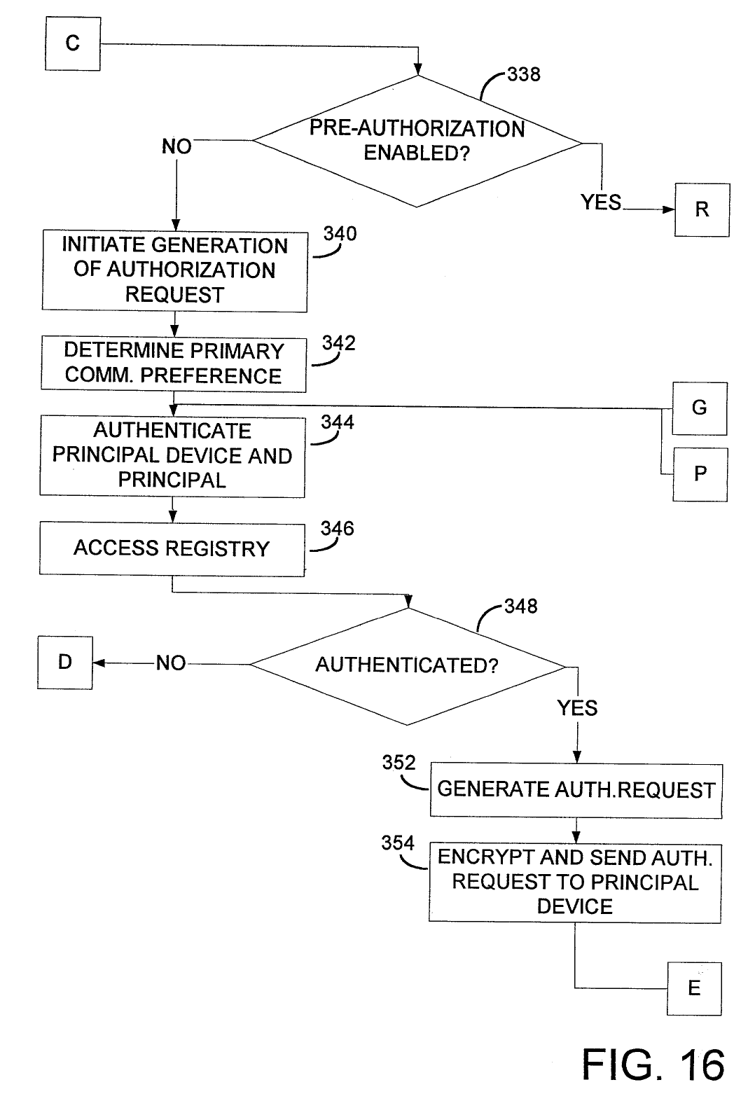

Referring to FIG. 16, at block 338, the pre-authorization decision component 120 determines if pre-authorization approval is enabled based on parameters within the principal preference decision rule component 94. If pre-authorization approval is not enabled, generation of an authorization request for sending to the principal device 18 is initiated at block 340. At block 342, the pre-authorization decision component 120 accesses the principal preference decision rule component 94 to determine the primary communication preference to contact the principal 20. In the exemplary operation, the principal device 18 has been previously identified in the principal preference decision rule component 94 as the primary communication preference. Authentication of the principal device 18 and the principal 20 is initiated with the verification of device/principal component 106 at block 344.

At block 346, the verification of device/principal component 106 accesses the registry component 90 to perform the authentication. The results of the authentication are determined at block 348. If authentication fails, the operation returns to block 324 of FIG. 15 and a transaction request denied message is returned to the beneficiary device 12 via the service provider 14. If authentication was successful, the message creator component 72 is activated to generate the authorization request at block 352. At block 354, the authorization request is encrypted with the public key of the principal device 18 by the encryption component 76 and forwarded by the Tx component 78 to the principal device 18.

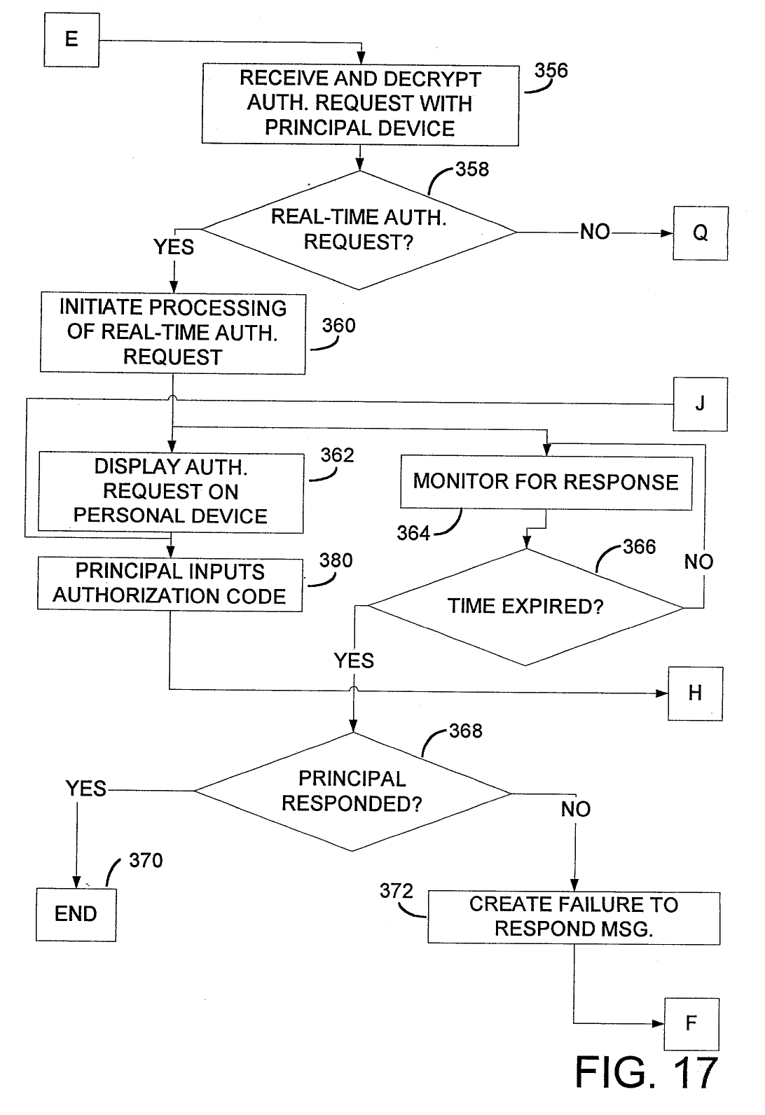

Referring now to FIG. 17, the encrypted authorization request is received and decrypted by the principal device 18 at block 356. At block 358, the message analyzer component 70 analyzes the contents to identify whether the authorization request is a real-time authorization request. If yes, the request is forwarded to the real-time authorization component 160 to initiate processing at block 360. As previously discussed, real-time authorization requests typically require authorization approval by the principal 20 to proceed, whereas non-real time authorization requests are usually confirmation of a pre-authorization approved by the proxy server 16.

The real-time authorization component 160 forwards information from the authorization request to the information display/user input controller component 156 for display on the display 152 at block 362. In addition, the timer component 150 is initiated to begin timing and monitoring for a response from the principal 20 at block 364. At block 366, the timer component 150 determines if the time has expired. If no, the timer component 150 returns to block 364 and continues monitoring. If yes, the timer component 150 determines if the principal 20 has responded at block 368. If yes, timing with the timing component ends at block 370. If the principal 20 has not responded, the timer component 150 activates the message creator component 72 to encapsulate a failure to respond message in an authorization response at block 372.

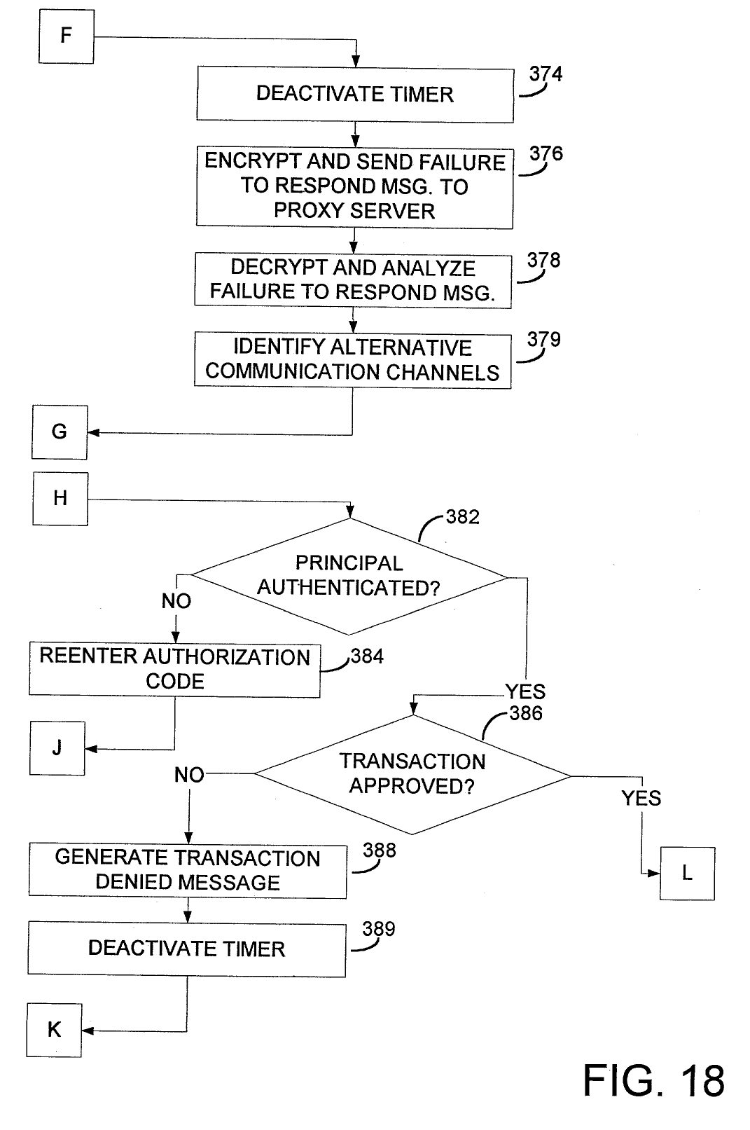

Referring now to FIG. 18, at block 374, the timer component 150 is deactivated. At block 376, the authorization response is encrypted by the encryption component 76 and transmitted to the proxy server 16 and identified as a failure to respond message with the Tx component 78. The encrypted authorization response is decrypted, analyzed and identified as a failure to respond message at the proxy server 16 at block 378. At block 379, the pre-authorization decision component 120 uses the principal preference decision rule component 94 to identify alternative communication channels designated by the principal 20. The operation then returns to block 344 (FIG. 16).

Referring again to block 362 of FIG. 17, if the time out period has not expired, at block 380, the principal 20 reviews the display and inputs an authorization code (i.e., PIN) via the user input component 154.

Referring again to FIG. 18, the authorization of the principal 20 by the verification of principal component 114 occurs at block 382. If the authorization was unsuccessful, the principal 20 is requested to reenter the authorization code at block 384 and the operation returns to block 380 (FIG. 17). If authentication is successful, determination of whether the principal 20 approved the transaction with an input via the user input component 154 occurs at block 386. If the principal 20 denies the transaction request, the message creator component 72 is activated to encapsulate a transaction denied message in the authorization response at block 388. The timer component 150 is deactivated at block 389. The operation then returns to block 324 (FIG. 15) and the transaction denied message is sent via the service provider 14 to the beneficiary device 12.

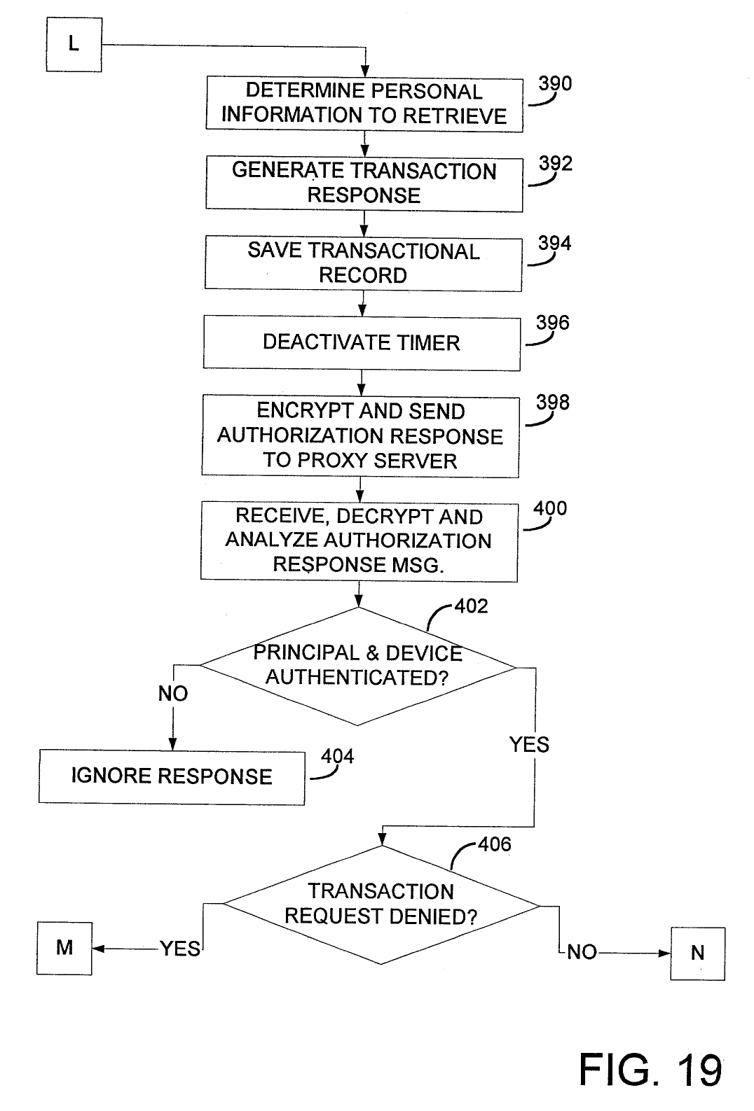

Referring now to FIG. 19, if the transaction is approved, the authorization component 162 determines which personal information is retrieved from the principal database 144 based on the authorization code at block 390. The authorized personal information retrieved from principal database 144 along with an authorization for the transaction is encapsulated in an authorization response by the message creator component 72 at block 392. At block 394, a transactional record is saved to the transaction record data 170 in the principal database 144. The timer component 150 is deactivated at block 396. At block 398, the authorization response is encrypted and sent to the proxy server 16.

At block 400, the proxy server 16 receives, decrypts and analyzes the authorization response from the principal device 18. The authorization response is verified with the verification of device/principal component 106 to authenticate the principal device 18 and the principal 20 at block 402. If the authentication fails, the authentication response is ignored at block 404. If the authentication is successful, the authentication response is analyzed by the message analyzer component 70 to determine if the transaction request was denied at block 406. If yes, the operation returns to block 324 (FIG. 15).

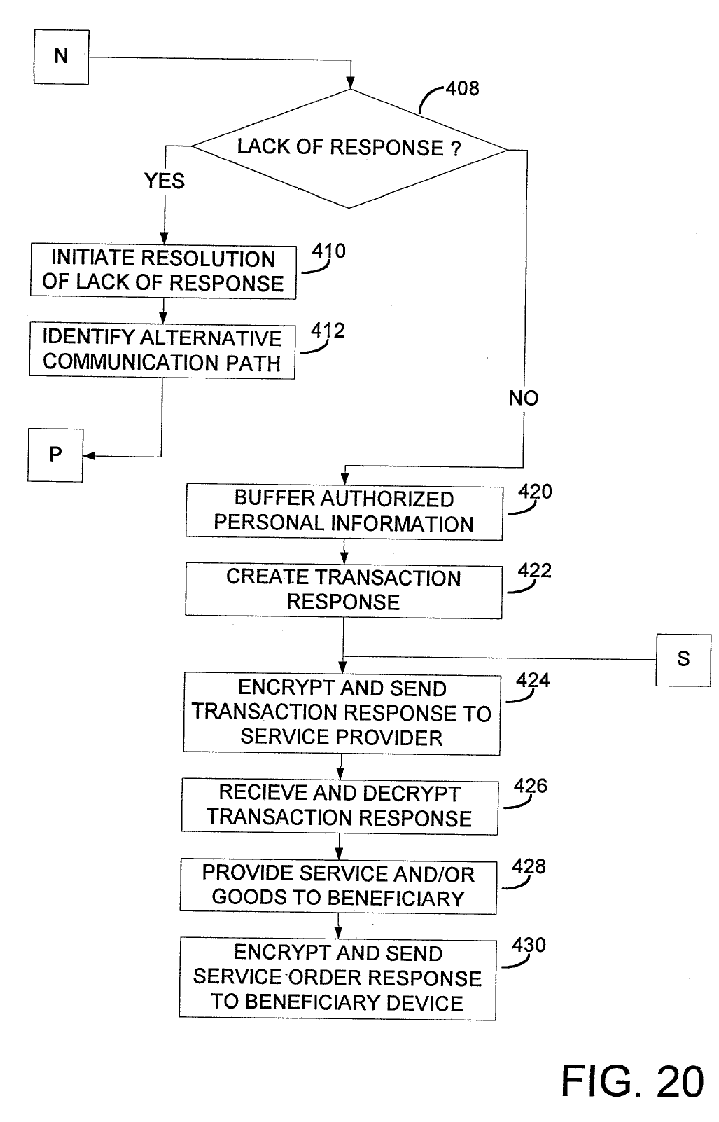

Referring now to FIG. 20, if the authorization response was not denied, the transaction request is analyzed to determine if authorization response indicates a lack of response by the principal 20 to a real-time authorization request at block 408. As previously discussed, a lack of response may be indicated by time-out of the timer component 150 reflecting the unavailability of the principal 20 to respond. If the transaction request indicates a lack of response, the pre-authorization decision component 120 is activated to initiate resolution of the unresolved (no-answer) real-time authorization request at block 410. At block 412, the pre-authorization decision component 120 accesses the principal preference decision rule component 94 to identify an alternative communication path previously specified by the principal 20. The operation then returns to block 344 (FIG. 16) to transmit the real-time authorization response to the principal 20 with the alternative communication path identified.

If the analysis at block 408 indicates the transaction response does not indicate lack of response, the transaction response is a transaction approval and the authorized personal information is buffered at block 420 with the personal information buffer 96 until the transaction response is prepared. At block 422, the message creator component 72 is activated to create the transaction response. The message creator component 72 encapsulates the authentication approval from block 322 (FIG. 15) and the proxy server transaction ID along with the authorization approval and the authorized personal information to create the transaction response. At block 424, the transaction response is encrypted with the public key of the service provider 14 and sent to the service provider 14. The service provider 14 receives and decrypts the transaction response with corresponding private key at block 426. At block 428, the service provider 14 provides the service and/or goods to the beneficiary 24. The service provider 14 encrypts a service order response with the public key of the beneficiary device 12 and encrypts the service order response with the public key and transmits the service order response to the beneficiary device 12 at block 430.

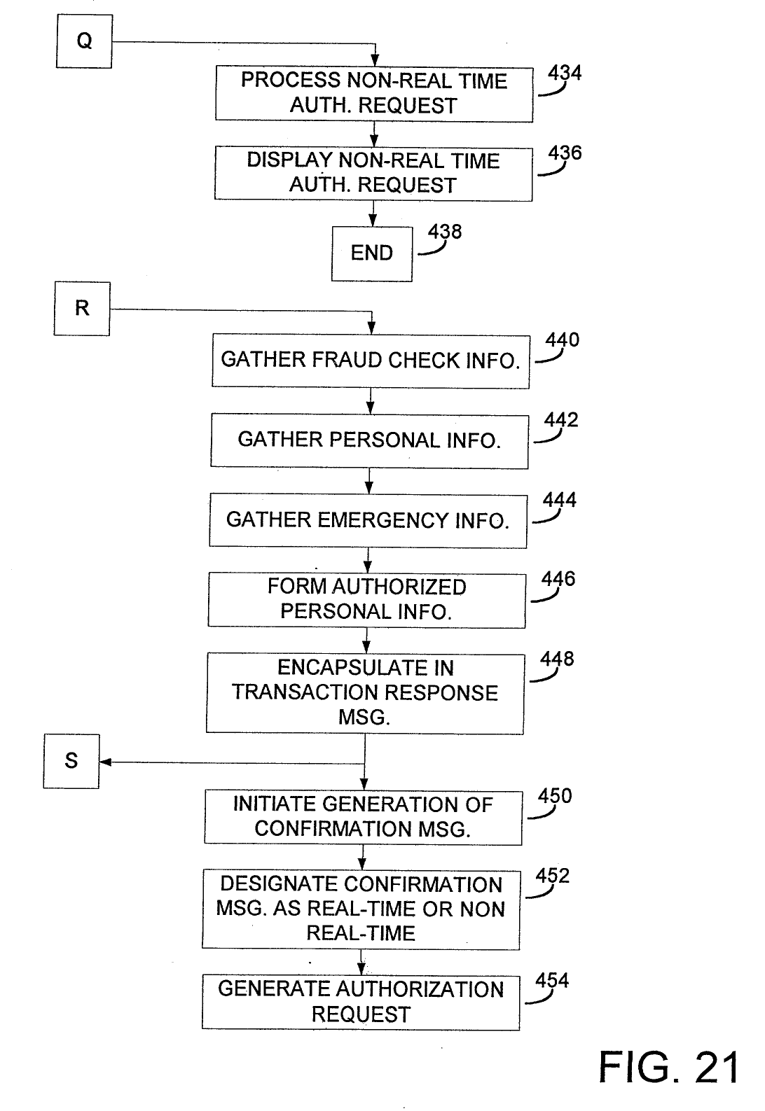

Referring now to FIG. 21, if the request is not a real-time authorization request, the request at block 358 of FIG. 17 is forwarded to the non-real time authorization component 158 for processing at block 434. At block 436, the non-real time authorization component 158 processes the transaction request and forwards information from the authorization request to the information display/user input controller component 156 for display on the display component 152. At block 438, the operation ends.

If the pre-authorization decision component 120 determines pre-authorization approval with the proxy server 16 is enabled at block 338 of FIG. 16, the pre-authorization decision component 120 gathers fraud check information from principal preference decision rule component 94 at block 440 of FIG. 21. At block 442, the pre-authorization decision component 120 gathers personal information from the preset information component 92. Additional personal information is gathered from the emergency information component 100 at block 444. At block 446, the gathered information forms the authorized personal information. The authorized personal information is sent to the message creator component 72 for encapsulation in a transaction response message at block 448. The operation then returns to block 424 RIG. 20) to send a transaction response to the proxy server 16.

In addition, at block 450, the confirm component 122 is activated to initiate generation of a confirmation message to the principal device 18. At block 452, the confirm component 122 accesses the principal preference decision rule component 94 to determine whether the confirmation message should be designated as a non-real time or a real-time message. The designated confirmation message is sent to the message creator component 72 for encapsulation in an authorization request and send to the principal device 18 at block 454. The encryption, transmission, receipt, decryption, analysis and display of the authorization request is similar to previously discussed operations.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of approving a request for an on-line transaction with a service provider, the on-line transaction requested by a beneficiary over an electronic communication channel, the method comprising:
a) subscribing a principal to an on-line transaction approval system;
b) enabling a beneficiary to access the on-line transaction approval system;
c) transmitting a service order request from the beneficiary to a service provider;
d) querying a proxy server with the service provider for authentication of the beneficiary and authorization by the principal of the transaction request; and
e) returning authorized personal information to the service provider to complete the on-line transaction as a function of authentication approval of the beneficiary and authorization approval by the principal.

2. The method of claim 1, wherein the service order request comprises a beneficiary ID and a beneficiary password and c) comprises encrypting the beneficiary ID and the beneficiary password with a public key of the proxy server.

3. The method of claim 1, wherein d) comprises generating a request comprising a beneficiary ID, a beneficiary password, a service provider ID, service information, a request for beneficiary authentication, a request for principal authorization and a public key of the service provider.

4. The method of claim 1, wherein d) comprises transmitting a request for authorization to a principal device of the principal, the request for authorization comprising a service provider ID, service information and a beneficiary ID.

5. The method of claim 1, wherein d) comprises authenticating the beneficiary with the proxy server as a function of a beneficiary ID and a beneficiary password.

6. The method of claim 1, wherein e) comprises transmitting an authorization approval from a principal device of the principal via the proxy server to the service provider, the authorization approval message comprising authorization for the transaction and the authorized personal information.

7. The method of claim 6, wherein transmitting the authorization approval comprises extracting the authorized personal information from storage in the principal device.

8. The method of claim 6, wherein transmitting the authorization approval comprises encrypting the authorization approval with a public key of the proxy server,

9. The method of claim 6, wherein transmitting the authorization approval comprises encrypting the authorization message with a public key of the service provider.

10. A method of approving a request for an on-line transaction with a service provider, the on-line transaction requested by a beneficiary over an electronic communication channel, the method comprising:
a) enabling a beneficiary with access to a user account of a principal for on-line transactions;
b) receiving a transaction request as a function of an on-line transaction initiated by the beneficiary;
c) processing the transaction request for authorization by the principal; and
d) transmitting authorized personal information of the principal to enable completion of the on-line transaction when the on-line transaction is authorized by the principal.

11. The method of claim 10, wherein c) comprises authenticating the identity of the beneficiary.

12. The method of claim 10, wherein c) comprises pre-authorizing the online transaction in real time with a proxy server as a function of parameters preconfigured by the principal.

13. The method of claim 12, wherein authorizing the on-line transaction with the proxy server comprises notifying the principal of the pre-authorization

14. The method of claim 10, wherein d) comprises authorizing the on-line transaction in real time with a principal device operated by the principal.

15. The method of claim 10, wherein d) comprises supplying the authorized personal information from a database in a proxy server.

16. The method of claim 10, wherein d) comprises supplying the authorized personal information from a database of a principal device operated by the principal.

17. A method of approving a request for an on-line transaction with a service provider, the on-line transaction requested by a beneficiary over an electronic communication channel, the method comprising:
a) subscribing a principal to an on-line transaction approval system;
b) enabling a beneficiary to utilize the on-line transaction approval system;
c) receiving an authorization request with a principal device of the principal as a function of an on-line transaction initiated by the beneficiary;
d) selectively authorizing the on-line transaction in real time with the principal device as a function of the identity of the beneficiary and the nature of the on-line transaction; and
e) transmitting authorized personal information from the principal device to enable completion of the on-line transaction.

18. The method of claim 17, wherein a) comprises maintaining personal information of the principal only in a database of the principal device.

19. The method of claim 17, wherein c) comprises:
monitoring the response time of the principal to the request; and
selecting a different communication mechanism when the response time exceeds a selected time period.

20. The method of claim 17, wherein d) comprises storing a transaction record in the principal device, the transaction record comprising identification of the beneficiary and the nature of the transaction.

21. An on-line transaction approval system for approving a request for an on-line transaction with a service provider, the on-line transaction requested by a beneficiary over an electronic communication channel, the on-line transaction approval system comprising:
a service provider in communication with a beneficiary, the service provider operable to receive a service order request from the beneficiary, the service order request comprising a beneficiary ID and a beneficiary password; and
a proxy server in communication with the service provider, the proxy server operable to receive a transaction request from the service provider as a function of the service order, the transaction request comprising the beneficiary ID, the beneficiary password and transaction information;
the proxy server operable to provide authorized personal information to the service provider as a function of authentication of the beneficiary and authorization approval by a principal, the beneficiary enabled with access to make the service order request by the principal.

22. The on-line transaction approval system of claim 21, further comprising a principal device in communication with the proxy server, the principal device operable to receive indication of the transaction request.

23. The on-line transaction approval system of claim 21, wherein the principal device comprises a database, the personal information of the principal stored only in the database.

24. The on-line transaction approval system of claim 21, wherein the proxy server comprises a pre-authorization decision component, the pre-authorization decision component operable to selectively authorize the transaction request as a function of parameters established by the principal.

25. The on-line transaction approval system of claim 21, wherein the proxy server comprises a preset information component, personal information of the principal is stored in the preset information component for use when the proxy server is operable to provide pre-authorization approval of the transaction request as a function of parameters established by the principal.

26. The on-line transaction approval system of claim 21, wherein the proxy server comprises a proxy database module, an authentication module and an authorization module.

27. The on-line transaction approval system of claim 22, wherein the principal device comprises a user interface module, an authorization module, a principal database, a verification of principal component, a device information component and a timer component.

28. The on-line transaction approval system of claim 21, wherein authorized personal information comprises credit card information.
